(19) United States
(12) Patent Application Publication
(10) Pub. No.: US 2023/0401973 A1
(43) Pub. Date: Dec. 14, 2023

(54) METHODS, SYSTEMS, APPARATUSES, AND DEVICES FOR FACILITATING EVALUATION OF USER KNOWLEDGE USING MULTIPLE-CHOICE QUESTIONS

(71) Applicant: Mario Altimari, Cambridge (GB)

(72) Inventor: Mario Altimari, Cambridge (GB)

(21) Appl. No.: 17/838,305

(22) Filed: Jun. 13, 2022

(51) Int. Cl. G09B 7/06; G06N 5/02

(52) U.S. Cl. CPC G09B 7/06; G06N 5/022; G06Q 50/34

(57) ABSTRACT

Disclosed herein is a method of evaluating user knowledge using multiple-choice questions. Accordingly, the method may include retrieving, using a storage device, an assessment module and transmitting, using the communication device, the assessment module to a student device, wherein the assessment module comprises a multiple choice question and options. Further, the method may include receiving, using the communication device, bets corresponding to the options from the at least one student device, retrieving, using the storage device, an assessment answer module comprising correct probabilities, analyzing, using the processing device, the bets and the correct probabilities, generating, using the processing device, a knowledge score based on the analyzing of the plurality of bets and the correct probabilities, transmitting, using the communication device, the knowledge score to an examiner device and the student device, and storing, using the storage device, the bets and the knowledge score.

### FIELD OF THE INVENTION

Generally, the present disclosure relates to the field of data processing. More specifically, the present disclosure relates to methods, systems, apparatuses, and devices for facilitating evaluation of user knowledge using multiple-choice questions.

### BACKGROUND OF THE INVENTION

The field of data processing is technologically important to several industries, business organizations, and/or individuals.

In connection with the verification of training, applications such as online education require users to answer correctly through MCQ (Multiple Choice Questions), picking the right answer from the available choices of a list.

However, using MCQs for evaluating user knowledge is deficient in regard to several aspects. For instance, the MCQs do not adequately evaluate problem-solving skills. Furthermore, the MCQs do not evaluate higher-order reasoning skills. Further, in a tricky MCQ, where the answer to select is not trivial, only “right” or “wrong” is not enough to judge the user's knowledge. Moreover, the MCQs do not determine how close the user is to be right or wrong, i.e., it does not provide information about the degree of a user's knowledge. Users can just guess and a lucky user could be incorrectly evaluated. A technique to discover who is guessing requires a certain amount of answers already given from the user, which means a short verification of knowledge is not applicable. Another technique to mitigate the guessing is to adopt a “slider” of confidence, where the user indicates their certainty about the answer, however, this is typically misused in practice (most users choose always 100% confidence) because unusual and counterintuitive in the case of negative questions (called “odd-one-out” questions, in which the correct answer is the false one).

Therefore, there is a need for improved methods, systems, apparatuses, and devices for facilitating evaluation of user knowledge using multiple-choice questions that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of evaluating user knowledge using multiple-choice questions, in accordance with some embodiments. Accordingly, the method may include retrieving, using a storage device, at least one assessment module. Further, the at least one assessment module may include a multiple-choice question and a plurality of options associated with the multiple-choice question. Further, the method may include transmitting, using a communication device, the at least one assessment module to at least one student device associated with at least one student. Further, the method may include receiving, using the communication device, a plurality of bets corresponding to the plurality of options from the at least one student device. Further, a first bet of the plurality of bets corresponding to a first option of the plurality of options may be a first measure of correctness of the first option in relation to the multiple-choice question. Further, a second bet of the plurality of bets corresponding to a second option of the plurality of options may be a second measure of correctness of the second option in relation to the multiple-choice question. Further, the method may include retrieving, using the storage device, at least one assessment answer module. Further, the method may include analyzing, using a processing device, the plurality of bets and the plurality of correct probabilities. Further, the method may include generating, using the processing device, a knowledge score based on the analyzing of the plurality of bets and the plurality of correct probabilities. Further, the method may include transmitting, using the communication device, the knowledge score to at least one of at least one examiner device and the at least one student device. Further, the method may include storing, using the storage device, at least one of the plurality of bets and the knowledge score.

Further disclosed herein is a system of evaluating user knowledge using multiple-choice questions, in accordance with some embodiments. Accordingly, the system may include a communication device configured for transmitting at least one assessment module to at least one student device associated with at least one student. Further, the communication device may be configured for receiving a plurality of bets corresponding to a plurality of options from the at least one student device. Further, a first bet of the plurality of bets corresponding to a first option of the plurality of options may be a first measure of correctness of the first option in relation to a multiple-choice question. Further, a second bet of the plurality of bets corresponding to a second option of the plurality of options may be a second measure of correctness of the second option in relation to the multiple-choice question. Further, the communication device may be configured for transmitting a knowledge score to at least one of at least one examiner device and the at least one student device. Further, the system may include a processing device communicatively coupled with the communication device. Further, the processing device may be configured for analyzing the plurality of bets and a plurality of correct probabilities. Further, the processing device may be configured for generating the knowledge score based on the analyzing of the plurality of bets and the plurality of correct probabilities. Further, the system may include a storage device communicatively coupled with the processing device. Further, the storage device may be configured for retrieving the at least one assessment module. Further, the at least one assessment module may include the multiple-choice question and the plurality of options associated with the multiple-choice question. Further, the storage device may be configured for retrieving at least one assessment answer module. Further, the at least one assessment answer module may include the plurality of correct probabilities corresponding to the plurality of options of the multiple-choice question. Further, the storage device may be configured for storing at least one of the plurality of bets and the knowledge score.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a flowchart of a method of evaluating user knowledge using multiple-choice questions, in accordance with some embodiments.

FIG. 2 is a flowchart of a method of evaluating user knowledge using multiple-choice questions, in accordance with some embodiments.

FIG. 3 is a flowchart of a method of evaluating user knowledge using multiple-choice questions, in accordance with some embodiments.

FIG. 4 is a flowchart of a method of evaluating user knowledge using multiple-choice questions, in accordance with some embodiments.

FIG. 5 is a flowchart of a method of evaluating user knowledge using multiple-choice questions, in accordance with some embodiments.

FIG. 6 is a flowchart of a method of evaluating user knowledge using multiple-choice questions, in accordance with some embodiments.

FIG. 7 is a flowchart of a method of evaluating user knowledge using multiple-choice questions, in accordance with some embodiments.

FIG. 8 is a block diagram of a system of evaluating user knowledge using multiple-choice questions, in accordance with some embodiments.

FIG. 9 is a block diagram of the system of evaluating user knowledge using multiple-choice questions, in accordance with some embodiments.

FIG. 10 is a flow chart of a method for economic incentivisation for evaluation of user knowledge using multiple-choice questions, in accordance with some embodiments.

FIG. 11 is a flow chart of a method for economic incentivisation for evaluation of user knowledge using multiple-choice questions, in accordance with some embodiments.

FIG. 12 is a flow diagram of a process for economic incentivisation for evaluation of user knowledge using multiple-choice questions, in accordance with some embodiments.

FIG. 13 is a continuous flow diagram of the process for economic incentivisation for evaluation of user knowledge using multiple-choice questions, in accordance with some embodiments.

FIG. 14 is an illustration of an online platform consistent with various embodiments of the present disclosure.

FIG. 15 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices of facilitating evaluation of user knowledge using multiple-choice questions, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, physical state and/or physiological state and/or psychological state of the user, and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor) associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods, systems, apparatuses, and devices for facilitating evaluation of user knowledge using multiple-choice questions.

In this context, the disclosed system may be associated with following user types:
an evaluated user (generally a student or a learner)
an evaluator user (generally a teacher or examiner or the author or creator of the MCQ)

In this context, the disclosed methods may include following processes:
bet on the right answer
continue to submit the answer
top-up credit when the budget is running out
skip to the next question when the topic of the assessment is unknown
ask for a hint when the topic of the assessment is not fully unknown
MCQ selector (machine learning algorithm selecting MCQ based on difficulty)
answer generator (machine learning algorithm generating MCQ answers)

In this context coins may include but are not limited to:
fiat and digital currencies, real or virtual tokens, cryptocurrencies, digital reward tokens, physical tokens, etc.

Further, the disclosed system may be configured to automatically generate multiple answers to MCQ that exhibit the desired variability in correctness using a machine learning algorithm. Further, the disclosed system may be configured to automatically generate wrong answers via a second machine learning algorithm based on a corpus of learning material and the correct answer provided by the user evaluator. Further, the disclosed system may be configured to analyze the betting behavior of the evaluated user and automatically adapt the variability in the correctness of subsequent question-answers using a machine-learning algorithm. Further, the machine learning algorithm is trained to provide difficult MCQ only at the end of the learning journey to stimulate evaluated users to continue the learning process (avoiding making them frustrated quickly) but also to motivate on top-up when the evaluated user is close to the end.

In order to have honest, unbiased, cheat-free, non-random answers, the disclosed system asks the evaluated user to bet a certain amount of coins from a budget received at the start of the assessment. Further, the budget may not be paid by the evaluated user, it is the promised win for a perfect knowledge verification during the assessment phase (or learning journey). Further, the disclosed method may include an “earn to learn” process, that promotes learning without any payment or even receiving payment that may give resources to deserving students.

However, if the evaluated user ends up consuming all the available budget, the evaluated user may top up to continue with the examination. In case the evaluated user does not know the answer, the evaluated user may skip the question and go to the next MCQ, paying a micro fee as a penalty. Further, the disclosed system may provide an opportunity to receive hints for a correct answer in exchange for payment of extra coins, coming from the budget (or available budget) or a top-up. This is the way the disclosed system may become lucrative and sustainable.

Further, the disclosed system may allow the student (or examined student) to save the budget from wrong bets and cashout at the end of the evaluation. Further, the coins lost from wrong answers go to an evaluator that created the MCQ. Further, the scope of the evaluator is to provide as much as possible difficult/non-trivial MCQ, in order to cash out at the end of every examination process.

Non-binary information increases deeply the understanding of the evaluated user's knowledge and it can be automatically managed using the disclosed system, preserving fast evaluation and fast administration. Further, the disclosed system may be configured for the evaluation of problem-solving and higher-order reasoning skills.

Further, the disclosed system may improve the quality of knowledge verification.

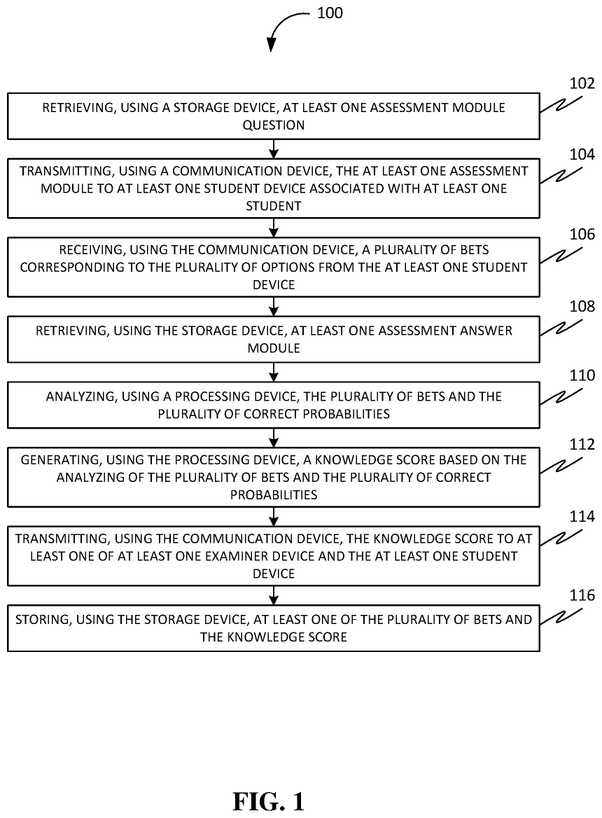

Referring now to figures, FIG. 1 is a flowchart of a method 100 of evaluating user knowledge using multiple-choice questions, in accordance with some embodiments. Accordingly, at 102, the method 100 may include retrieving, using a storage device (such as a storage device 806), at least one assessment module. Further, the at least one assessment module may include a multiple-choice question and a plurality of options associated with the multiple-choice question.

Further, at 104, the method 100 may include transmitting, using a communication device (such as a communication device 802), the at least one assessment module to at least one student device (such as at least one student device 902) associated with at least one student.

Further, at 106, the method 100 may include receiving, using the communication device, a plurality of bets corresponding to the plurality of options from the at least one student device. Further, a first bet of the plurality of bets corresponding to a first option of the plurality of options may be a first measure of correctness of the first option in relation to the multiple-choice question. Further, a second bet of the plurality of bets corresponding to a second option of the plurality of options may be a second measure of correctness of the second option in relation to the multiple-choice question.

Further, at 108, the method 100 may include retrieving, using the storage device, at least one assessment answer module. Further, the at least one assessment answer module may include a plurality of correct probabilities corresponding to the plurality of options of the multiple-choice question.

Further, at 110, the method 100 may include analyzing, using a processing device (such as a processing device 804), the plurality of bets and the plurality of correct probabilities.

Further, at 112, the method 100 may include generating, using the processing device, a knowledge score based on the analyzing of the plurality of bets and the plurality of correct probabilities.

Further, at 114, the method 100 may include transmitting, using the communication device, the knowledge score to at least one of at least one examiner device (such as at least one examiner device 904) and the at least one student device.

Further, at 116, the method 100 may include storing, using the storage device, at least one of the plurality of bets and the knowledge score.

Further, in some embodiments, the multiple-choice question may include a first multiple-choice question and a second multiple-choice question. Further, the first multiple-choice question may be associated with a first plurality of options. Further, the second multiple-choice question may be associated with a second plurality of options. Further, the first multiple-choice question may be presented on the at least one student device at a first time instant. Further, the second multiple-choice question may be presented on the at least one student device at a second time instant later than the first time instant. Further, the knowledge score may include a first knowledge score corresponding to the first multiple-choice question. Further, the method 100 may include generating, using the processing device, the second plurality of options based on the first knowledge score.

Further, in some embodiments, the method 100 may include receiving, using the communication device, a specified variability of correctness corresponding to the second plurality of options from the at least one examiner device. Further, the generating of the second plurality of options may be based on the specified variability of correctness.

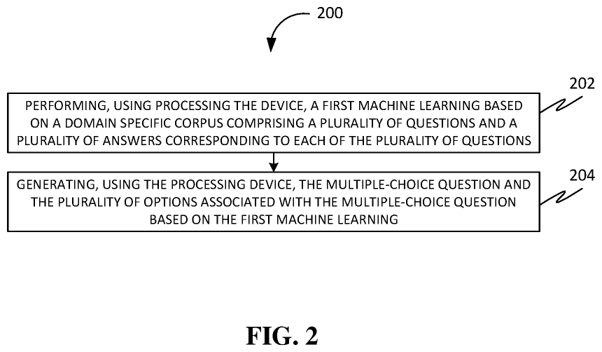

FIG. 2 is a flowchart of a method 200 of evaluating user knowledge using multiple-choice questions, in accordance with some embodiments. Accordingly, at 202, the method 200 may include performing, using processing the device, a first machine learning based on a domain specific corpus comprising a plurality of questions and a plurality of answers corresponding to each of the plurality of questions.

Further, at 204, the method 200 may include generating, using the processing device, the multiple-choice question and the plurality of options associated with the multiple-choice question based on the first machine learning.

Further, in some embodiments, the method 200 may include receiving, using the communication device, a specified variability of correctness corresponding to the plurality of options from the at least one examiner device. Further, the generating of the multiple-choice question and the plurality of options associated with the multiple-choice question may be based on the specified variability of correctness.

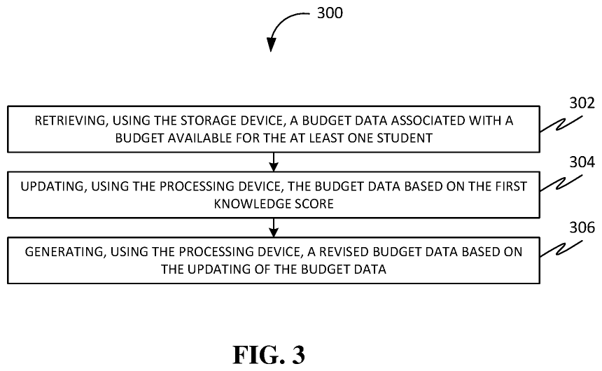

FIG. 3 is a flowchart of a method 300 of evaluating user knowledge using multiple-choice questions, in accordance with some embodiments. Accordingly, at 302, the method 300 may include retrieving, using the storage device, a budget data associated with a budget available for the at least one student. Further, the at least one student places the plurality of bets using the budget. Further, the at least one student places the plurality of bets using the budget.

Further, at 304, the method 300 may include updating, using the processing device, the budget data based on the first knowledge score.

Further, at 306, the method 300 may include generating, using the processing device, a revised budget data based on the updating of the budget data. Further, the revised budget data corresponds to a revised budget. Further, the transmitting of the second multiple-choice question and the second plurality of options may be based on the revised budget data.

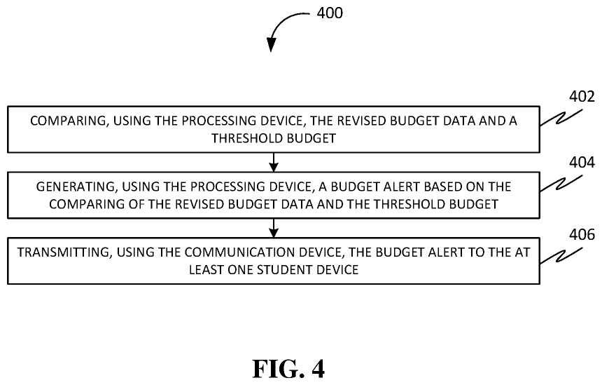

FIG. 4 is a flowchart of a method 400 of evaluating user knowledge using multiple-choice questions, in accordance with some embodiments. Accordingly, at 402, the method 400 may include comparing, using the processing device, the revised budget data and a threshold budget. Further, the threshold budget may include a minimum budget required for betting to answer the at least one question.

Further, at 404, the method 400 may include generating, using the processing device, a budget alert based on the comparing of the revised budget data and the threshold budget. Further, the budget alert may inform the at least one student that the revised budget is low than the minimum budget for answering the at least one question. Further, the generating of the knowledge score may be based on the revised budget.

Further, at 406, the method 400 may include transmitting, using the communication device, the budget alert to the at least one student device. Further, in some embodiments, the method 400 may include transmitting, using the communication device, the revised budget data to the at least one student device.

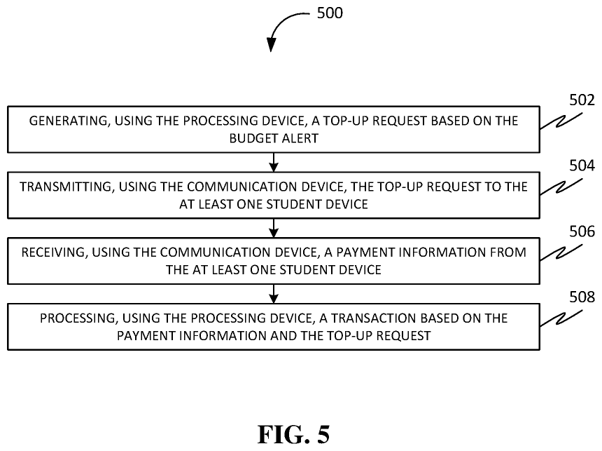

FIG. 5 is a flowchart of a method 500 of evaluating user knowledge using multiple-choice questions, in accordance with some embodiments. Accordingly, at 502, the method 500 may include generating, using the processing device, a top-up request based on the budget alert.

Further, at 504, the method 500 may include transmitting, using the communication device, the top-up request to the at least one student device.

Further, at 506, the method 500 may include receiving, using the communication device, a payment information from the at least one student device.

Further, at 508, the method 500 may include processing, using the processing device, a transaction based on the payment information and the top-up request. Further, the generating of the revised budget data may be based on the processing of the transaction.

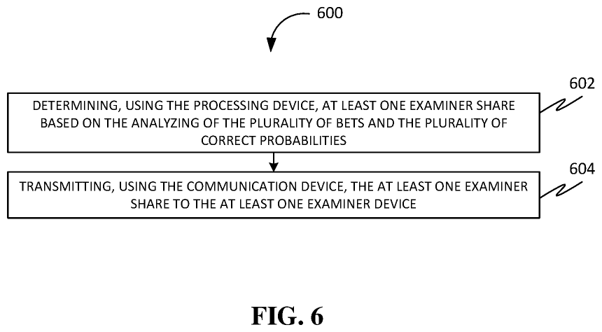

FIG. 6 is a flowchart of a method 600 of evaluating user knowledge using multiple-choice questions, in accordance with some embodiments. Accordingly, at 602, the method 600 may include determining, using the processing device, at least one examiner share based on the analyzing of the plurality of bets and the plurality of correct probabilities. Further, the at least one examiner share reflects money distributed among at least one examiner. Further, the money corresponds to at least one bet of the plurality of bets placed on at least one wrong option of the plurality of options.

Further, at 604, the method 600 may include transmitting, using the communication device, the at least one examiner share to the at least one examiner device.

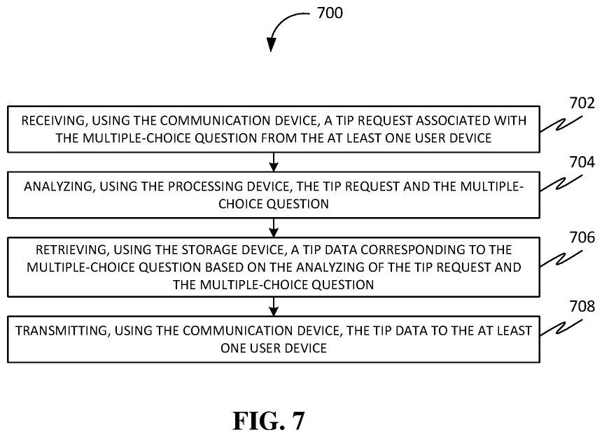

FIG. 7 is a flowchart of a method 700 of evaluating user knowledge using multiple-choice questions, in accordance with some embodiments. Accordingly, at 702, the method 700 may include receiving, using the communication device, a tip request associated with the multiple-choice question from the at least one student device. Further, the tip request may indicate that the at least one student may be facing difficulty in the at least one question and want to receive a hint or tip to the correct answer for the at least one question.

Further, at 704, the method 700 may include analyzing, using the processing device, the tip request and the multiple-choice question.

Further, at 706, the method 700 may include retrieving, using the storage device, a tip data corresponding to the multiple-choice question based on the analyzing of the tip request and the multiple-choice question.

Further, at 708, the method 700 may include transmitting, using the communication device, the tip data to the at least one student device.

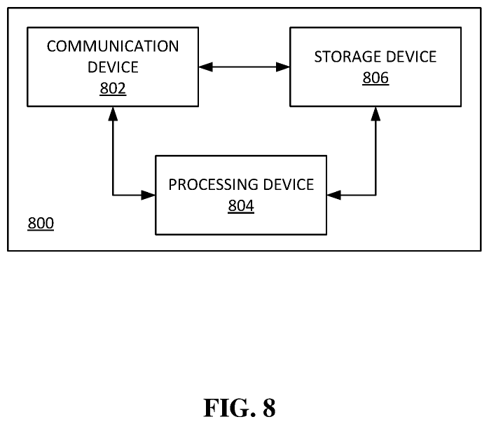

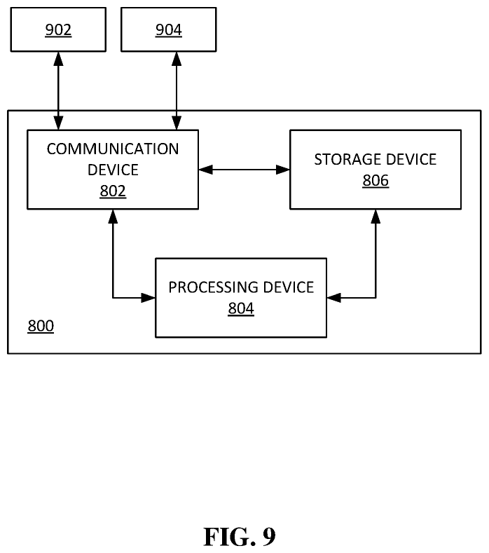

FIG. 8 is a block diagram of a system 800 of evaluating user knowledge using multiple-choice questions, in accordance with some embodiments. Accordingly, the system 800 may include a communication device 802 configured for transmitting at least one assessment module to at least one student device 902 (as shown in FIG. 9) associated with at least one student. Further, the communication device 802 may be configured for receiving a plurality of bets corresponding to a plurality of options from the at least one student device 902. Further, a first bet of the plurality of bets corresponding to a first option of the plurality of options may be a first measure of correctness of the first option in relation to a multiple-choice question. Further, a second bet of the plurality of bets corresponding to a second option of the plurality of options may be a second measure of correctness of the second option in relation to the multiple-choice question. Further, the communication device 802 may be configured for transmitting a knowledge score to at least one of at least one examiner device 904 (as shown in FIG. 9) and the at least one student device 902.

Further, the system 800 may include a processing device 804 communicatively coupled with the communication device 802. Further, the processing device 804 may be configured for analyzing the plurality of bets and a plurality of correct probabilities. Further, the processing device 804 may be configured for generating the knowledge score based on the analyzing of the plurality of bets and the plurality of correct probabilities.

Further, the system 800 may include a storage device 806 communicatively coupled with the processing device 804. Further, the storage device 806 may be configured for retrieving the at least one assessment module. Further, the at least one assessment module may include the multiple-choice question and the plurality of options associated with the multiple-choice question. Further, the storage device 806 may be configured for retrieving at least one assessment answer module. Further, the at least one assessment answer module may include the plurality of correct probabilities corresponding to the plurality of options of the multiple-choice question. Further, the storage device 806 may be configured for storing at least one of the plurality of bets and the knowledge score.

Further, in some embodiments, the processing device 804 may be configured for performing a first machine learning based on a domain specific corpus comprising a plurality of questions and a plurality of answers corresponding to each of the plurality of questions. Further, the processing device 804 may be configured for generating the multiple-choice question and the plurality of options associated with the multiple-choice question based on the first machine learning.

Further, in some embodiments, the communication device 802 may be configured for receiving a specified variability of correctness corresponding to the plurality of options from the at least one examiner device 904. Further, the generating of the multiple-choice question and the plurality of options associated with the multiple-choice question may be based on the specified variability of correctness.

Further, in some embodiments, the multiple-choice question may include a first multiple-choice question and a second multiple-choice question. Further, the first multiple-choice question may be associated with a first plurality of options. Further, the second multiple-choice question may be associated with a second plurality of options. Further, the first multiple-choice question may be presented on the at least one student device 902 at a first time instant. Further, the second multiple-choice question may be presented on the at least one student device 902 at a second time instant later than the first time instant. Further, the knowledge score may include a first knowledge score corresponding to the first multiple-choice question. Further, the processing device 804 may be configured for generating the second plurality of options based on the first knowledge score.

Further, in some embodiments, the communication device 802 may be configured for receiving a specified variability of correctness corresponding to the second plurality of options from the at least one examiner device 904. Further, the generating of the second plurality of options may be based on the specified variability of correctness.

Further, in some embodiments, the storage device 806 may be configured for retrieving a budget data associated with a budget available for the at least one student. Further, the processing device 804 may be configured for updating the budget data based on the first knowledge score. Further, the processing device 804 may be configured for generating a revised budget data based on the updating of the budget data. Further, the transmitting of the second multiple-choice question and the second plurality of options may be based on the revised budget data.

Further, in some embodiments, the processing device 804 may be configured for comparing the revised budget data and a threshold budget. Further, the processing device 804 may be configured for generating a budget alert based on the comparing of the revised budget data and the threshold budget. Further, the communication device 802 may be configured for transmitting the budget alert to the at least one student device 902. Further, in some embodiments, the communication device 802 may be configured for transmitting the revised budget data to the at least one student device 902.

Further, in some embodiments, the processing device 804 may be configured for generating a top-up request based on the budget alert. Further, the processing device 804 may be configured for processing a transaction based on a payment information and the top-up request. Further, the generating of the revised budget data may be based on the processing of the transaction. Further, the communication device 802 may be configured for transmitting the top-up request to the at least one student device 902. Further, the communication device 802 may be configured for receiving the payment information from the at least one student device 902.

Further, in some embodiments, the processing device 804 may be configured for determining at least one examiner share based on the analyzing of the plurality of bets and the plurality of correct probabilities. Further, the at least one examiner share reflects money distributed among at least one examiner. Further, the money corresponds to at least one bet of the plurality of bets placed on at least one wrong option of the plurality of options. Further, the communication device 802 may be configured for transmitting the at least one examiner share to the at least one examiner device 904.

Further, in some embodiments, the communication device 802 may be configured for receiving a tip request associated with the multiple-choice question from the at least one student device 902. Further, the tip request may indicate that the at least one student may be facing difficulty in the at least one question and want to receive a hint or tip to the correct answer for the at least one question. Further, the communication device 802 may be configured for transmitting a tip data to the at least one student device 902. Further, the processing device 804 may be configured for analyzing the tip request and the multiple-choice question. Further, the storage device 806 may be configured for retrieving the tip data corresponding to the multiple-choice question based on the analyzing of the tip request and the multiple-choice question. Further, the tip data may include a textual content, a graphical content, etc. associated with the correct answer. Further, the graphical content may include an image, a video, an audio, an audio-video, etc.

Further, in some embodiments, the generating of the revised budget data may be based on the transmitting of the tip data. Further, an amount equivalent to a bet placed for the tip may be deducted from a revised budget corresponding to the revised budget data.

FIG. 9 is a block diagram of the system 800 of evaluating user knowledge using multiple-choice questions, in accordance with some embodiments.

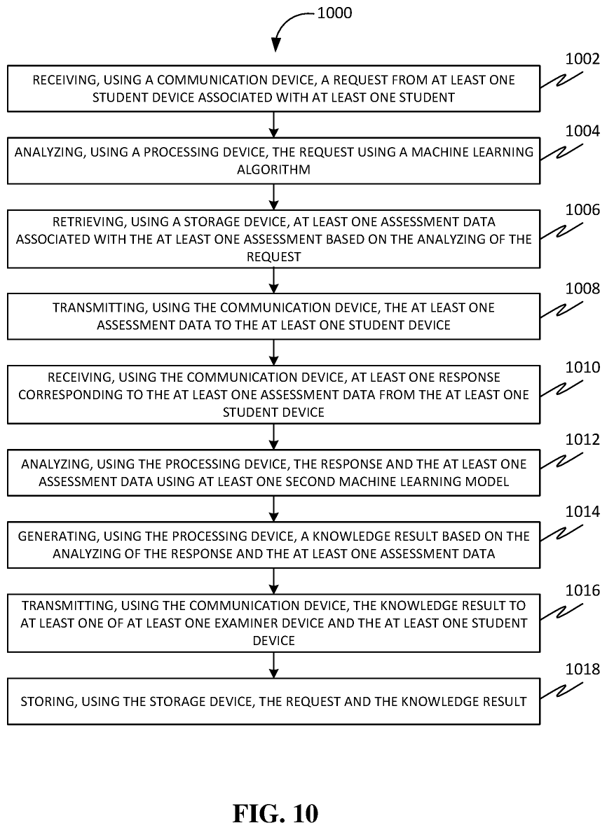

FIG. 10 is a flow chart of a method 1000 for economic incentivisation for evaluation of user knowledge using multiple-choice questions, in accordance with some embodiments. Accordingly, at 1002, the method 1000 may include receiving, using a communication device, a request from at least one student device associated with at least one student. Further, the at least one student device may include a smartphone, a tablet, a mobile, a computer, a laptop, and so on. Further, the at least one student may include an individual that may want to undergo at least one assessment. Further, the request may indicate that the at least one student may want to initiate the at least one assessment. Further, the request may include a student data comprising student name, a student learning standard, an institute name, an email address, an address, a contact number, etc. Further, the request may include a budget data comprising a budget equivalent to a certain amount of coins (or digital coins).

Further, at 1004, the method 1000 may include analyzing, using a processing device, the request using a machine learning algorithm.

Further, at 1006, the method 1000 may include retrieving, using a storage device, at least one assessment data associated with the at least one assessment based on the analyzing of the request. Further, the at least one assessment data may include at least one question such as multiple-choice questions (MCQs).

Further, at 1008, the method 1000 may include transmitting, using the communication device, the at least one assessment data to the at least one student device.

Further, at 1010, the method 1000 may include receiving, using the communication device, at least one response corresponding to the at least one assessment data from the at least one student device. Further, the at least one response may include at least one option chosen by the at least one student for the at least one question. Further, the at least one student may bet a certain amount of the coins for the at least answer. Further, the at least one answer may include a probability corresponding to each option of at least one option being correct. Further, the at least one question may include the at least one option.

Further, at 1012, the method 1000 may include analyzing, using the processing device, the response and the at least one assessment data using at least one second machine learning algorithm.

Further, at 1014, the method 1000 may include generating, using the processing device, a knowledge result based on the analyzing of the response and the at least one assessment data. Further, the knowledge result may evaluate user knowledge for the at least one assessment. Further, the knowledge result may indicate a level of problem-solving skills and higher-order reasoning skills of the at least one student.

Further, at 1016, the method 1000 may include transmitting, using the communication device, the knowledge result to at least one of at least one examiner device and the at least one student device. Further, the at least one examiner device may be associated with at least one examiner comprising an individual, an institution, and an organization that may want to conduct the at least one assessment. Further, the at least one examiner device may include a smartphone, a mobile, a tablet, a computer, and so on.

Further, at 1018, the method 1000 may include storing, using the storage device, the request and the knowledge result.

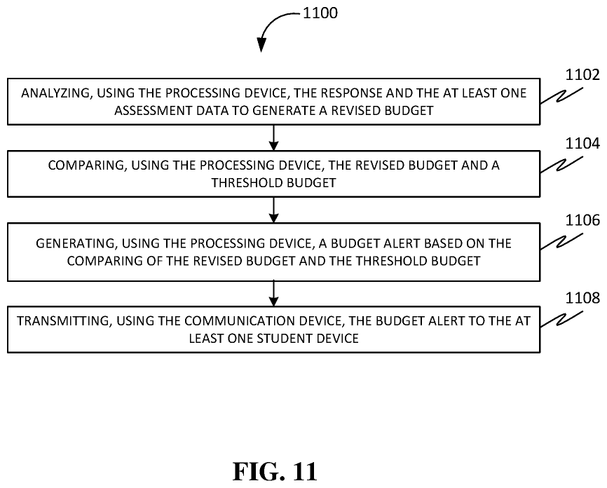

FIG. 11 is a flow chart of a method 1100 for economic incentivisation for evaluation of user knowledge using multiple-choice questions, in accordance with some embodiments. Accordingly, at 1102, the method 1100 may include analyzing, using the processing device, the response and the at least one assessment data to generate a revised budget. Further, the revised budget may indicate the budget left after answering a first question of the at least one question. Further, at 1104, the method 1100 may include comparing, using the processing device, the revised budget and a threshold budget. Further, the threshold budget may include a minimum budget required for betting to answer the at least one question. Further, at 1106, the method 1100 include generating, using the processing device, a budget alert based on the comparing of the revised budget and the threshold budget. Further, the budget alert may inform the at least one student that the revised budget is low than the minimum budget for answering the at least one question. Further, the generating of the knowledge result may be based on the revised budget. Further, at 1108, the method 1100 may include transmitting, using the communication device, the budget alert to the at least one student device. Further, in some embodiments, the method 1100 may include transmitting, using the communication device, the revised budget to the at least one student device.

Further, in some embodiments, the method 1100 may include generating, using the processing device, a top-up request based on the budget alert. Further, the top-up request may inform the at least one student to top-up the revised budget to continue the at least one assessment. Further, the method 1100 may include transmitting, using the communication device, the top-up request to the at least one student device. Further, the method 1100 may include receiving, using the communication device, a payment information from the at least one student device. Further, the method 1100 may include processing, using the processing device, a transaction based on the payment information and the top-up request. Further, the generating of the revised budget may be based on the processing of the transaction.

Further, in some embodiments, the method 1100 may include receiving, using the communication device, the at least one question and a correct answer from the at least one examiner device. Further, the method 1100 may include analyzing, using the processing device, the at least one question and the correct answer based on at least one third machine learning algorithm. Further, the method 1100 may include generating, using the processing device, the least one option based on the analyzing of the at least one question and the correct answer. Further, the at least one option may exhibit a desired variability of correctness with respect to the correct answer. Further, the at least one question and the at least one option may be comprised in the at least one assessment data. Further, the at least one option may include the correct answer along with wrong answers. Further, the method 1100 may include storing, using the storage device, the at least one assessment data.

Further, in some embodiments, the at least one assessment data may include a sequence of the at least one question that may be presented to the at least one student (such as the evaluated user). Further, in an instance, the sequence may include presenting a difficult question of the least one question only at the end of the assessment to stimulate the at least one evaluated user to continue the assessment (avoiding making him/her frustrated quickly) but also to motivate on top-up when the at least one evaluated user is close to the end. Further, the each of the at least one question may be characterized by a difficulty level. Further, the method 1100 may include determining, using the processing device, a betting behavior of the at least one student based on the analyzing of the at least one response and the at least one assessment data. Further, the method 1100 may include updating, using the processing device, the sequence based on the betting behavior. Further, the method 1100 may include generating, using the processing device, an updated sequence based on the updating. Further, the transmitting of the at least one assessment data may be based on the updated sequence.

Further, in some embodiments, the generating of the at least one option may be based on the betting behavior.

Further, in some embodiments, the method 1100 may include receiving, using the communication device, at least one sensor data from at least one sensor disposed in a surrounding of the at least one student. Further, the at least one sensor may include an audio sensor, an image sensor, a motion sensor, etc. Further, the at least one sensor may be configured for generating at least one sensor data based on determining a behavior of the at least one student. Further, the method 1100 may include analyzing, using the processing device, the at least one sensor data. Further, the method 1100 may include determining, using the processing device, a physical behavior characteristic of the at least one student based on the analyzing of the at least one sensor data. Further, the physical behavior characteristic may include the movements of the at least one student during the assessment. Further, the movements may include movement of the head, hands, etc. Further, the method 1100 may include generating, using the processing device, an unfair practice alert based on the determining of the physical behavior characteristic. Further, the generating of the knowledge result may be based on the unfair practice alert.

Further, in some embodiments, the method 1100 may include receiving, using the communication device, a tip request from the at least one student device. Further, the tip request may indicate that the at least one student may be facing difficulty in the at least one question and want to receive a hint or tip to the correct answer for the at least one question. Further, the method 1100 may include analyzing, using the processing device, the tip request, the at least one question, and the revised budget. Further, the method 1100 may include determining, using the processing device, a tip approval based on the analyzing of the tip request, the at least one question, and the revised budget. Further, the method 1100 may include retrieving, using the storage device, the tip data corresponding to the at least one question. Further, the tip data may include a textual content, a graphical content, etc. associated with the correct answer. Further, the graphical content may include an image, a video, an audio, an audio-video, etc. Further, the method 1100 may include transmitting, using the communication device, the tip data to the at least one student device. Further, the generating of the revised budget may be based on the transmitting of the tip data. Further, an amount equivalent to a bet placed for the tip may be deducted from the revised budget.

Further, in some embodiments, the at least one response may include a skipping response. Further, the skipping response may indicate that the at least one student didn't give an answer to the at least one question and proceeded to a next question of the at least one question. Further, the method 1100 may include deducting, using the processing device, a penalty amount from the revised budget based on the skipping response. Further, the penalty may be distributed across the at least one examiner (or evaluator) or a creator of the exam. Further, the method 1100 may include transmitting, using the processing device, the penalty amount to the at least one examiner device.

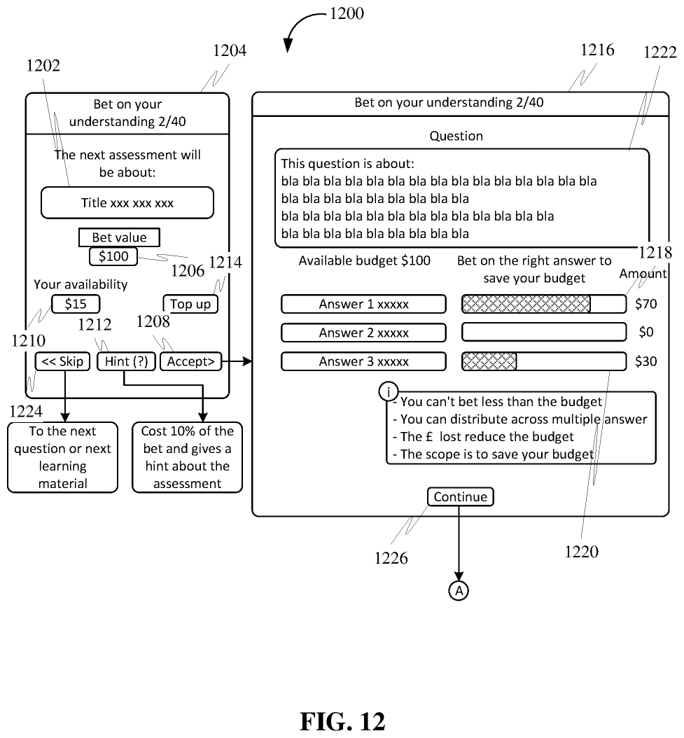

FIG. 12 is a flow diagram of a process 1200 for economic incentivisation for evaluation of user knowledge using multiple-choice questions, in accordance with some embodiments. Accordingly, at 1202, the process 1200 may include presenting an assessment title of an assessment journey to an evaluated user using a user interface 1204. Further, at 1206, the process 1200 may include asking an evaluated user to bet a certain amount of coins from a budget received at the start of the assessment journey. Further, in an instance, the bet value may be $100 (as an example), but this value changes based on the MCQ difficulty). Further, the budget may not be paid by the evaluated user. Further, it is the promised win for perfect knowledge verification during a learning journey or assessment. Further, at 1210, the user interface 1204 may show the available budget. However, if the evaluated user ends up consuming all the available budget, at 1214, the process 1200 may allow the evaluated user to top up to continue with the assessments or examination. Further, at 1208, upon clicking on Accept button, the evaluated user may agree to access the question corresponding to the assessment title. Further, at 1222, the process 1200 may include presenting a question to the evaluated user. Further, the process 1200 may include receiving bets for at least one of multiple choices available for the question (or MCQ) using a user interface 1216. Further, in an instance, at 1218 and 1220, the process 1200 may allow the evaluated user to place $70 (as an example) on a first answer of the multiple choices (or answers) and $30 (as an example) on a second answer of the multiple choices. In case the evaluated user doesn't know the topic in relation to the title, at 1202, of the question, at 1224, the process 1200 may allow the evaluated user to always skip it and go to a next question (MCQ) or next learning material by paying a micro fee as a penalty. Further, at 1212, the process 1200 may include providing a hint or tip to the evaluated user for a correct answer in exchange for payment of extra coins, coming from the available budget or a top-up. Further, in an instance, the tip may cost 10% of the bet for the question. Further, at 1226, the process 1200 may allow the evaluated user to continue to view the correct answer to the question by clicking on a continue button.

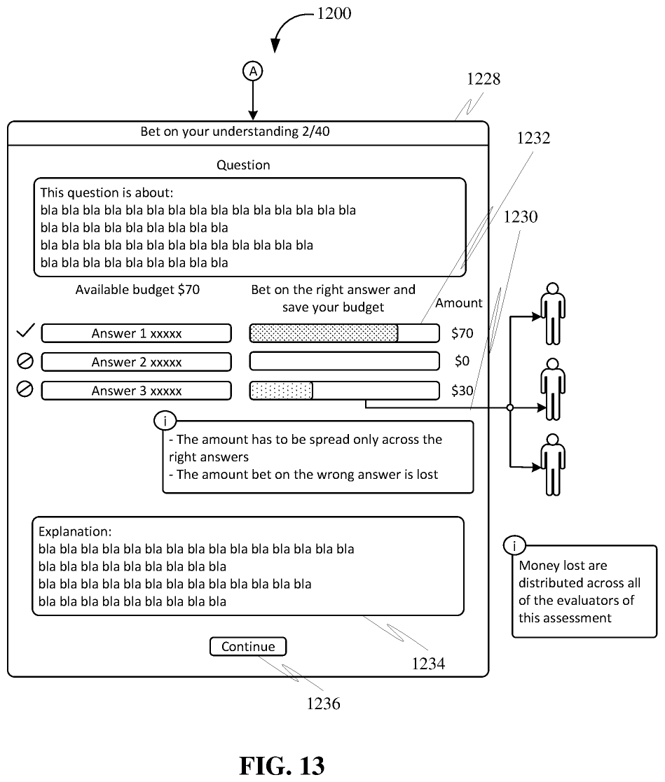

FIG. 13 is a continuous flow diagram of the process 1200 for economic incentivisation for evaluation of user knowledge using multiple-choice questions, in accordance with some embodiments. Accordingly, the process 1200 may include presenting the correct answer to the evaluated user using a user interface 1228. Further, the amount has to be spread only across the correct answers. Further, at 1230, the process 1200 may include distributing coins, lost by giving a wrong answer, to all evaluator users of the assessment. Further, at 1232, the process 1200 may include the evaluated user saving the budget by betting on the correct answer. Further, at 1234, the process 1200 may include presenting an explanation of the right answer corresponding to the question. Further, at 1236, the user interface 1228 may include a continue button to allow the evaluated user to continue to the next question. Further, the scope of the evaluator user is to provide as much as possible difficult/not-trivial MCQ in order to cash out at the end of every assessment.

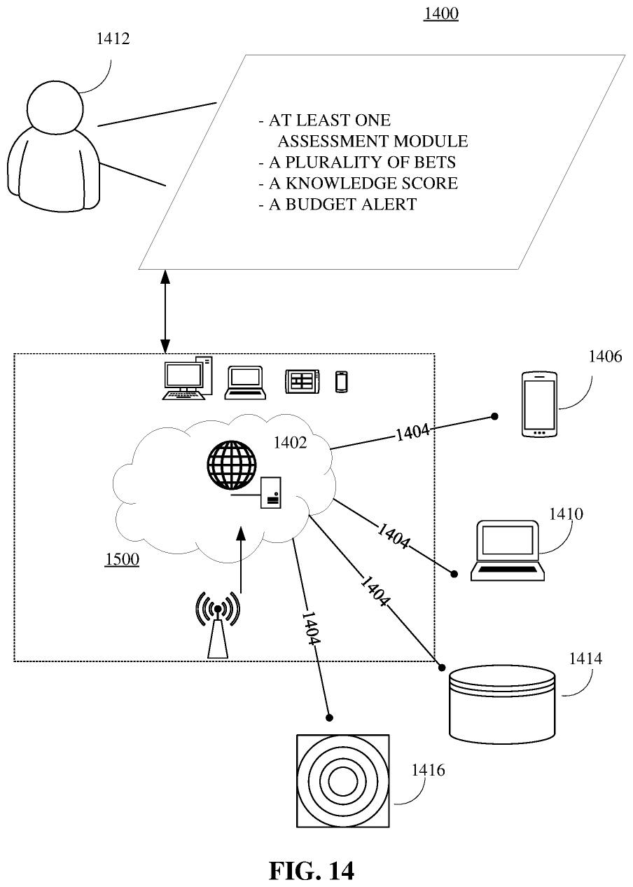

FIG. 14 is an illustration of an online platform 1400 consistent with various embodiments of the present disclosure. By way of non-limiting example, the online platform 1400 for facilitating evaluation of user knowledge using multiple-choice questions may be hosted on a centralized server 1402, such as, for example, a cloud computing service. The centralized server 1402 may communicate with other network entities, such as, for example, a mobile device 1406 (such as a smartphone, a laptop, a tablet computer, etc.), other electronic devices 1410 (such as desktop computers, server computers, etc.), databases 1414, and sensors 1416 over a communication network 1404, such as, but not limited to, the Internet. Further, users of the online platform 1400 may include relevant parties such as, but not limited to, end-users, administrators, service providers, service consumers, and so on. Accordingly, in some instances, electronic devices operated by the one or more relevant parties may be in communication with the platform.

A user 1412, such as the one or more relevant parties, may access online platform 1400 through a web-based software application or browser. The web-based software application may be embodied as, for example, but not be limited to, a website, a web application, a desktop application, and a mobile application compatible with a computing device 1500.

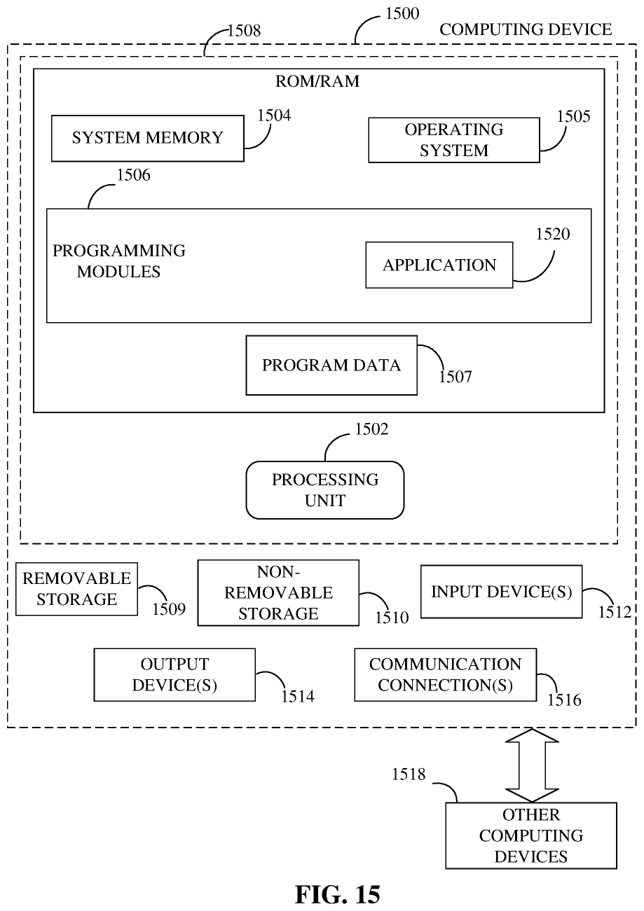

With reference to FIG. 15, a system consistent with an embodiment of the disclosure may include a computing device or cloud service, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random-access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500's operation. In one embodiment, programming modules 1506 may include image-processing module, machine learning module. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and non-volatile, removable and non-removable media implemented in any method or technology for storage of information, such as computer-readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, a location sensor, a camera, a biometric sensor, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., application 1520 such as a media player) may perform processes including, for example, one or more stages of methods, algorithms, systems, applications, servers, databases as described above. The aforementioned process is an example, and processing unit 1502 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. A method of evaluating user knowledge using multiple-choice questions, the method comprising:
retrieving, using a storage device, at least one assessment module, wherein the at least one assessment module comprises a multiple-choice question and a plurality of options associated with the multiple-choice question;
transmitting, using a communication device, the at least one assessment module to at least one student device associated with at least one student;
receiving, using the communication device, a plurality of bets corresponding to the plurality of options from the at least one student device, wherein a first bet of the plurality of bets corresponding to a first option of the plurality of options is a first measure of correctness of the first option in relation to the multiple-choice question, wherein a second bet of the plurality of bets corresponding to a second option of the plurality of options is a second measure of correctness of the second option in relation to the multiple-choice question;
retrieving, using the storage device, at least one assessment answer module, wherein the at least one assessment answer module comprises a plurality of correct probabilities corresponding to the plurality of options of the multiple-choice question;
analyzing, using a processing device, the plurality of bets and the plurality of correct probabilities;
generating, using the processing device, a knowledge score based on the analyzing of the plurality of bets and the plurality of correct probabilities;
transmitting, using the communication device, the knowledge score to at least one of at least one examiner device and the at least one student device; and
storing, using the storage device, at least one of the plurality of bets and the knowledge score.

2. The method of claim 1 further comprising:
performing, using processing the device, a first machine learning based on a domain specific corpus comprising a plurality of questions and a plurality of answers corresponding to each of the plurality of questions; and
generating, using the processing device, the multiple-choice question and the plurality of options associated with the multiple-choice question based on the first machine learning.

3. The method of claim 2 further comprising receiving, using the communication device, a specified variability of correctness corresponding to the plurality of options from the at least one examiner device, wherein the generating of the multiple-choice question and the plurality of options associated with the multiple-choice question is further based on the specified variability of correctness.

4. The method of claim 1, wherein the multiple-choice question comprises a first multiple-choice question and a second multiple-choice question, wherein the first multiple-choice question is associated with a first plurality of options, wherein the second multiple-choice question is associated with a second plurality of options, wherein the first multiple-choice question is presented on the at least one student device at a first time instant, wherein the second multiple-choice question is presented on the at least one student device at a second time instant later than the first time instant, wherein the knowledge score comprises a first knowledge score corresponding to the first multiple-choice question, wherein the method further comprises generating, using the processing device, the second plurality of options based on the first knowledge score.

5. The method of claim 4 further comprising receiving, using the communication device, a specified variability of correctness corresponding to the second plurality of options from the at least one examiner device, wherein the generating of the second plurality of options is further based on the specified variability of correctness.

6. The method of claim 4 further comprising:
retrieving, using the storage device, a budget data associated with a budget available for the at least one student, wherein the at least one student places the plurality of bets using the budget;
updating, using the processing device, the budget data based on the first knowledge score; and
generating, using the processing device, a revised budget data based on the updating of the budget data, wherein the transmitting of the second multiple-choice question and the second plurality of options is further based on the revised budget data.

7. The method of claim 6 further comprising:
comparing, using the processing device, the revised budget data and a threshold budget;
generating, using the processing device, a budget alert based on the comparing of the revised budget data and the threshold budget; and
transmitting, using the communication device, the budget alert to the at least one student device.

8. The method of claim 6 further comprising:
generating, using the processing device, a top-up request based on the budget alert;
transmitting, using the communication device, the top-up request to the at least one student device;
receiving, using the communication device, a payment information from the at least one student device; and
processing, using the processing device, a transaction based on the payment information and the top-up request, wherein the generating of the revised budget data is further based on the processing of the transaction.

9. The method of claim 1 further comprising:
determining, using the processing device, at least one examiner share based on the analyzing of the plurality of bets and the plurality of correct probabilities, wherein the at least one examiner share reflects money distributed among at least one examiner, wherein the money corresponds to at least one bet of the plurality of bets placed on at least one wrong option of the plurality of options; and
transmitting, using the communication device, the at least one examiner share to the at least one examiner device.

10. The method of claim 1 further comprising:
receiving, using the communication device, a tip request associated with the multiple-choice question from the at least one student device;
analyzing, using the processing device, the tip request and the multiple-choice question;
retrieving, using the storage device, a tip data corresponding to the multiple-choice question based on the analyzing of the tip request and the multiple-choice question; and
transmitting, using the communication device, the tip data to the at least one student device.

11. A system of evaluating user knowledge using multiple-choice questions, the system comprising:
a communication device configured for:
transmitting at least one assessment module to at least one student device associated with at least one student;
receiving a plurality of bets corresponding to a plurality of options from the at least one student device, wherein a first bet of the plurality of bets corresponding to a first option of the plurality of options is a first measure of correctness of the first option in relation to a multiple-choice question, wherein a second bet of the plurality of bets corresponding to a second option of the plurality of options is a second measure of correctness of the second option in relation to the multiple-choice question; and
transmitting a knowledge score to at least one of at least one examiner device and the at least one student device;
a processing device communicatively coupled with the communication device, wherein the processing device is configured for:
analyzing the plurality of bets and a plurality of correct probabilities; and
generating the knowledge score based on the analyzing of the plurality of bets and the plurality of correct probabilities; and
a storage device communicatively coupled with the processing device, wherein the storage device is configured for:
retrieving the at least one assessment module, wherein the at least one assessment module comprises the multiple-choice question and the plurality of options associated with the multiple-choice question;
retrieving at least one assessment answer module, wherein the at least one assessment answer module comprises the plurality of correct probabilities corresponding to the plurality of options of the multiple-choice question; and
storing at least one of the plurality of bets and the knowledge score.

12. The system of claim 11, wherein the processing device is further configured for:
performing a first machine learning based on a domain specific corpus comprising a plurality of questions and a plurality of answers corresponding to each of the plurality of questions; and
generating the multiple-choice question and the plurality of options associated with the multiple-choice question based on the first machine learning.

13. The system of claim 12, wherein the communication device is further configured for receiving a specified variability of correctness corresponding to the plurality of options from the at least one examiner device, wherein the generating of the multiple-choice question and the plurality of options associated with the multiple-choice question is further based on the specified variability of correctness.

14. The system of claim 11, wherein the multiple-choice question comprises a first multiple-choice question and a second multiple-choice question, wherein the first multiple-choice question is associated with a first plurality of options, wherein the second multiple-choice question is associated with a second plurality of options, wherein the first multiple-choice question is presented on the at least one student device at a first time instant, wherein the second multiple-choice question is presented on the at least one student device at a second time instant later than the first time instant, wherein the knowledge score comprises a first knowledge score corresponding to the first multiple-choice question, wherein the processing device is further configured for generating the second plurality of options based on the first knowledge score.

15. The system of claim 14, wherein the communication device is further configured for receiving a specified variability of correctness corresponding to the second plurality of options from the at least one examiner device, wherein the generating of the second plurality of options is further based on the specified variability of correctness.

16. The system of claim 14, wherein the storage device is further configured for retrieving a budget data associated with a budget available for the at least one student, wherein the processing device is further configured for:
updating the budget data based on the first knowledge score; and
generating a revised budget data based on the updating of the budget data, wherein the transmitting of the second multiple-choice question and the second plurality of options is further based on the revised budget data.

17. The system of claim 16, wherein the processing device is further configured for:
comparing the revised budget data and a threshold budget; and
generating a budget alert based on the comparing of the revised budget data and the threshold budget, wherein the communication device is further configured for transmitting the budget alert to the at least one student device.

18. The system of claim 16, wherein the processing device is further configured for:
generating a top-up request based on the budget alert; and
processing a transaction based on a payment information and the top-up request, wherein the generating of the revised budget data is further based on the processing of the transaction, wherein the communication device is further configured for:
transmitting the top-up request to the at least one student device; and
receiving the payment information from the at least one student device.

19. The system of claim 11, wherein the processing device is further configured for determining at least one examiner share based on the analyzing of the plurality of bets and the plurality of correct probabilities, wherein the at least one examiner share reflects money distributed among at least one examiner, wherein the money corresponds to at least one bet of the plurality of bets placed on at least one wrong option of the plurality of options, wherein the communication device is further configured for transmitting the at least one examiner share to the at least one examiner device.

20. The system of claim 11, wherein the communication device is further configured for:
receiving a tip request associated with the multiple-choice question from the at least one student device; and
transmitting a tip data to the at least one student device, wherein the processing device is further configured for analyzing the tip request and the multiple-choice question, wherein the storage device is further configured for retrieving the tip data corresponding to the multiple-choice question based on the analyzing of the tip request and the multiple-choice question.
